(19) United States
(12) Patent Application Publication
(10) Pub. No.: US 2014/0060484 A1
(43) Pub. Date: Mar. 6, 2014

(54) ELECTRIC ACTUATOR

(71) Applicant: DENSO CORPORATION, Kariya-city (JP)

(72) Inventors: Satoru HIRAMOTO, Nagoya-city (JP); Yasushi KAWANO, Anjo-city (JP); Yoshiyuki KONO, Obu-city (JP)

(73) Assignee: DENSO CORPORATION, Kariya-city (JP)

(21) Appl. No.: 14/012,201

(22) Filed: Aug. 28, 2013

(30) Foreign Application Priority Data
Aug. 29, 2012 (JP) 2012-189303

(51) Int. Cl. H02K 7/116

(52) U.S. Cl. CPC H02K 7/116
USPC 123/337; 310/83

(57) ABSTRACT

An electric actuator includes an electric motor, a gear deceleration device, a housing, and a motor attachment plate. The electric motor is configured to convert electric power into rotation output. The gear deceleration device is configured to decelerate the rotation output of the electric motor. The electric motor and the gear deceleration device are attached to the housing. The motor attachment plate is provided for the electric motor and is fixed to the housing. A first positioning hole, which is formed through the motor attachment plate, and a second positioning hole, which is provided for the housing coincide with each other in a state where the electric motor is attached to the housing.

### CROSS REFERENCE TO RELATED APPLICATION

This application is based on Japanese Patent Application No. 2012-189303 filed on Aug. 29, 2012, the disclosure of which is incorporated herein by reference.

### TECHNICAL FIELD

The present disclosure relates generally to an electric actuator including an electric motor and a gear deceleration device. In particular, the present disclosure relates to a technique for attaching the electric motor to a housing (body).

### BACKGROUND

In an electric actuator including an electric motor and a gear deceleration device, accuracy in attachment between a motor gear (e.g., pinion gear) provided for a rotatable shaft (output shaft) of the electric motor, and an intermediate gear in engagement with this motor gear needs to be improved. The electric motor is fixed to a housing, and the intermediate gear is supported rotatably by the housing. For this reason, to improve the accuracy of engagement between the motor gear and the intermediate gear, accuracy in attachment (positioning accuracy) of the electric motor to the housing needs to be increased. Accordingly, a shaft center of the electric motor is positioned using the motor gear to improve the accuracy of engagement between the motor gear and the intermediate gear.

However, only by positioning the shaft center of the electric motor by use of the motor gear, the electric motor rotates around the rotatable shaft, and there is made a position shift between a “screw hole (through hole) of the electric motor” and a “screw hole of the housing” in a rotation direction. As a result, there may be caused a defect in fastening a screw for fixing the electric motor to the housing.

A technology described in JP-A-2001-329868 is known as a technique for solving this issue. According to this technology in JP-A-2001-329868, (i) a motor positioning pin is additionally fixed to a housing, and (ii) a motor positioning hole is provided for a motor attachment plate of an electric motor. By fitting together the motor positioning pin and the motor positioning hole, the electric motor is positioned relative to the housing.

Nevertheless, in the technology in JP-A-2001-329868, because the motor positioning pin is additionally fixed to an electric actuator, there is an issue of a cost increase of the electric actuator due to the additional component (motor positioning pin).

As a measure against this, an intermediate shaft for rotatably supporting an intermediate gear may be used for the motor positioning pin. Having said that, if the intermediate shaft is used for the motor positioning pin, the intermediate shaft may be damaged at the time of attachment of the electric motor to increase rotational resistance of the intermediate gear. Accordingly, a strain (driving load) of the electric motor may be increased to reduce a rotation output of the electric actuator. In addition, the motor attachment plate needs to be provided to expand to the intermediate shaft, which causes a cost increase.

### SUMMARY

The present disclosure addresses at least one of the above issues.

According to the present disclosure, there is provided an electric actuator including an electric motor, a gear deceleration device, a housing, and a zo motor attachment plate. The electric motor is configured to convert electric power into rotation output. The gear deceleration device is configured to decelerate the rotation output of the electric motor. The electric motor and the gear deceleration device are attached to the housing. The motor attachment plate is provided for the electric motor and is fixed to the housing. A first positioning hole, which is formed through the motor attachment plate, and a second positioning hole, which is provided for the housing coincide with each other in a state where the electric motor is attached to the housing.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a sectional view illustrating an electronic throttle in accordance with a first embodiment;

FIG. 2 is an explanatory diagram at the time of attachment of an electric motor to a housing according to the first embodiment;

FIG. 3 is a diagram illustrating the electric motor attached to the housing, and a gear deceleration device viewed in an axial direction according to the first embodiment;

FIG. 4A is a diagram illustrating the electric motor of the first embodiment viewed in the axial direction;

FIG. 4B is a diagram illustrating the housing of the first embodiment viewed in the axial direction;

FIG. 5 is an explanatory drawing at the time of attachment of an electric motor to a housing in accordance with a second embodiment;

FIG. 6 is a diagram illustrating an electric motor attached to a housing, and a gear deceleration device viewed in an axial direction in accordance with a third embodiment;

FIG. 7A is a diagram illustrating the electric motor of the third embodiment viewed in the axial direction; and

FIG. 7B is a diagram illustrating the housing of the third embodiment viewed in the axial direction.

### DETAILED DESCRIPTION

Embodiments will be described in detail below with reference to the accompanying drawings.

The following embodiments are specific examples to which the present disclosure is applied, and the present disclosure is obviously not limited to the embodiments.

### First Embodiment

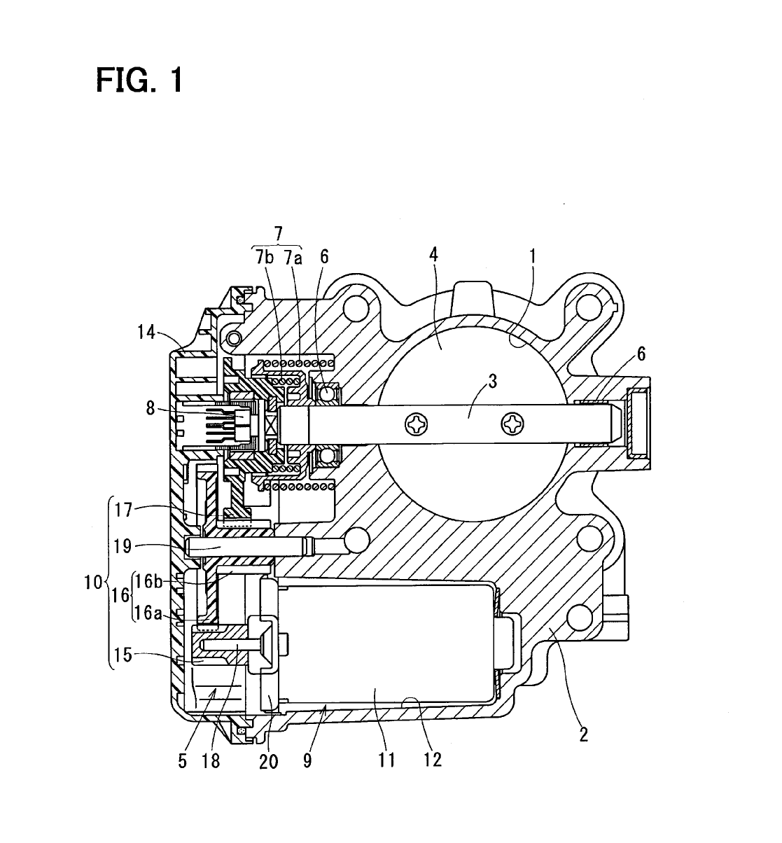

A fist embodiment will be described in reference to FIGS. 1 to 4B. This embodiment is an application of the present disclosure to an electronic throttle, and a configuration of the electronic throttle will be explained first. The electronic throttle regulates the amount of intake air drawn into an engine for vehicle traveling, and is arranged between an air cleaner and an inlet manifold.

The electronic throttle of this embodiment includes (a) a housing 2 in which an intake passage 1 is formed; (b) a shaft 3 supported rotatably by this housing 2; (c) a butterfly valve 4 fixed to a shaft 3 in the intake passage 1 to regulate an opening degree of the intake passage 1; and (d) an electric actuator 5 for driving the butterfly valve 4 via the shaft 3.

The housing 2 is a passage forming member produced from a metallic material or resin material. The cylindrical intake passage 1 (specifically, a part of the intake passage 1 leading to the engine) is formed in the housing 2.

The shaft 3 has a generally cylindrical rod shape which is formed from a metallic material, and is inserted and disposed in the intake passage 1 to rotate together with the butterfly valve 4. The shaft 3 is supported rotatably by the housing 2 via bearings 6 arranged on both sides of the shaft 3. The butterfly valve 4 is a rotatable valve that is formed in a generally disc shape from a metallic material or resin material, and is fixed to the shaft 3 which is incorporated into the housing 2. The butterfly valve 4 is rotated integrally with the shaft 3 inside the intake passage 1 to change an opening area of the intake passage 1.

The electric actuator 5 includes (e) a spring force generating means 7 for returning the butterfly valve 4 to a predetermined opening degree; (f) a rotational angle sensor 8 for detecting a rotation angle of the butterfly valve 4; (g) an electric motor 9 for converting electric power into rotation output (rotation power); and (h) a gear deceleration device 10 for decelerating this rotation output (torque increased) of the electric motor 9 to drive the shaft 3.

When supply of an electric current to the electric motor 9 is shut off, the spring force generating means 7 holds an opening degree of the butterfly valve 4 at an intermediate position between a fully-closed position and a fully-open position so as to enable evacuation traveling of the vehicle. The spring force generating means 7 includes a return spring 7a for applying urging force (valve-closing force) in a direction to close the butterfly valve 4, and an open spring 7b for applying urging force (valve-opening force) in a direction to open the butterfly valve 4.

The rotational angle sensor 8 is a position sensor that detects the opening degree of the butterfly valve 4 in a contactless manner through detection of a rotation angle of the shaft 3, and outputs an opening degree signal to an engine control unit (ECU).

The electric motor 9 is a known direct-current motor whose rotation direction is switched as a result of switching of an energizing direction and which generates rotation torque in accordance with the energizing amount. After a main part (cylindrical main body) 11 of the electric motor 9 is inserted into a motor accommodating chamber 12 which is formed in the housing 2, the electric motor 9 is fixed to the housing 2 by a screw 13.

The gear deceleration device 10 is accommodated and disposed inside a gear accommodating space formed between the housing 2 and a cover 14. This gear deceleration device 10 is a speed reducer for decelerating the rotation torque produced by the electric motor 9 through a combination of gears to transmit the torque to the shaft 3, and includes a motor gear 15 that rotates integrally with the electric motor 9, an intermediate gear 16 that is rotated by this motor gear 15, and an output gear (last gear) 17 that is rotated by this intermediate gear 16.

The motor gear 15 is a small-diameter external gear (pinion gear) fixed to a rotatable shaft 18 of the electric motor 9. The intermediate gear 16 is a double gear in which a large-diameter gear 16a and a small-diameter gear 16b are concentrically arranged, and is supported rotatably by an intermediate shaft 19 which is attached to the housing 2. The large-diameter gear 16a is constantly in engagement with the motor gear 15, and the small-diameter gear 16b is constantly in engagement with the output gear 17.

The output gear 17 is an external gear made of resin obtained by inserting a metal plate which is joined to an end of the shaft 3, and its external teeth are provided only in a range of engagement with the small-diameter gear 16b. The rotation torque of the electric motor 9, which is amplified by the deceleration in order of the motor gear 15, the large-diameter gear 16a, the small-diameter gear 16b, and the output gear 17, is transmitted to the rotation shaft 3.

A technique for attachment of the electric motor 9 will be described below. A positioning technique for reliably carrying out the screwing of the screw 13 at the time of attachment of the electric motor 9, and a positioning technique for improving accuracy in engagement between the motor gear 15 and the intermediate gear 16 are employed for the electric actuator 5 of this embodiment.

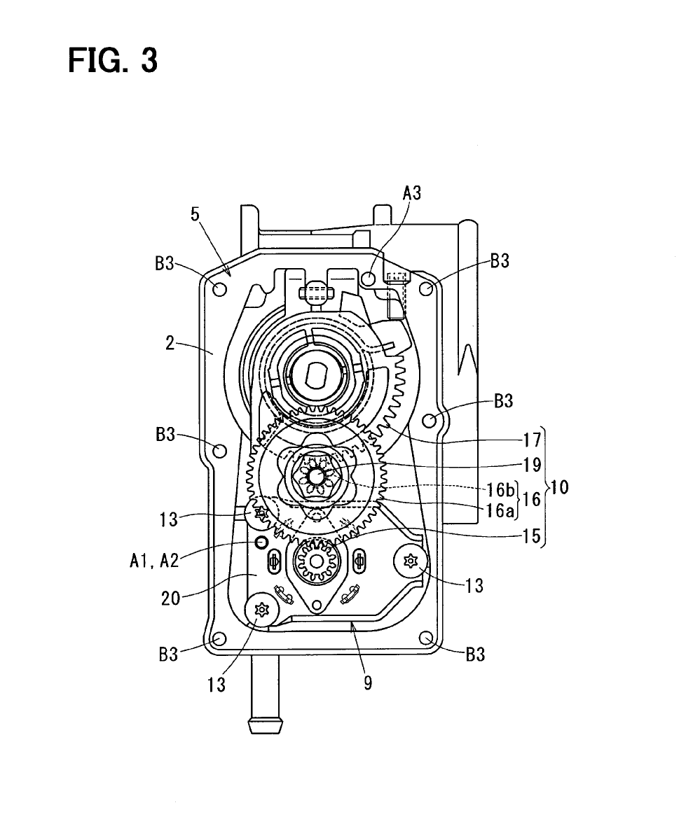

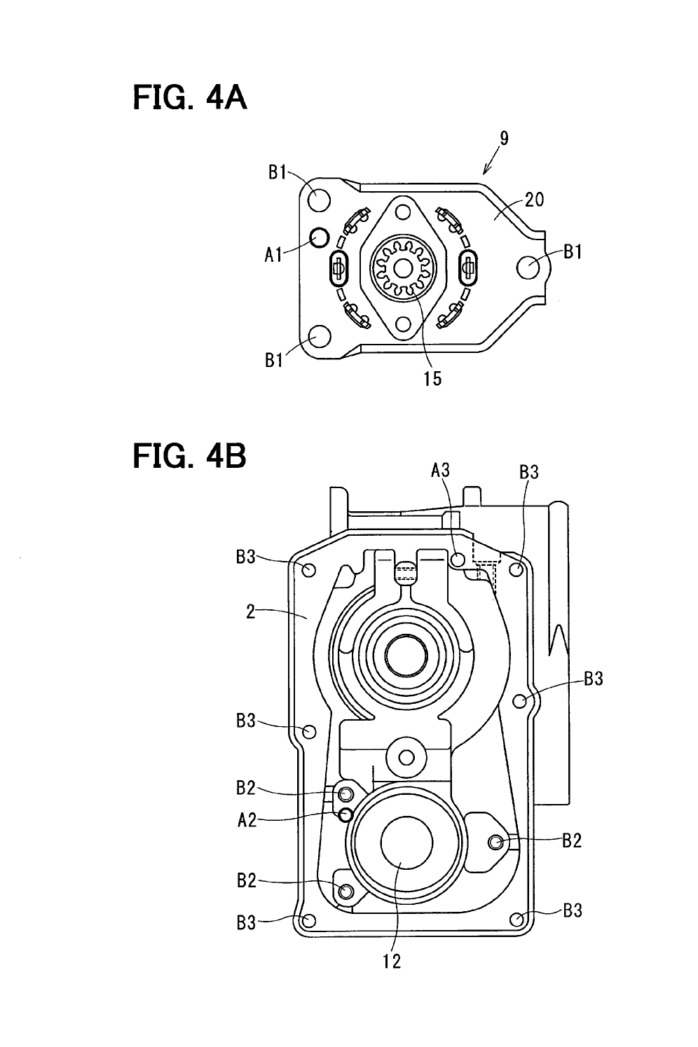

In the electric actuator 5 of this embodiment, with the electric motor 9 attached to the housing 2 (see FIG. 3), (i) a first positioning hole Al (see FIG. 4A) formed through a motor attachment plate 20 of the electric motor 9, and (ii) a second positioning hole A2 (see FIG. 4B) provided for the housing 2 coincide with each other.

The technique for attachment of the electric motor 9 will be explained. The electric motor 9 includes the motor attachment plate 20 disposed along a direction perpendicular to the rotatable shaft 18. This motor attachment plate 20 is a product by press-forming of a metal plate, and includes more than one (in this embodiment, three) first screw hole (through hole) B1 through which the screws 13 are respectively inserted, and the one first positioning hole (through hole) Al as illustrated in FIG. 4A.

On the other hand, as illustrated in FIG. 4B, more than one (in this embodiment, three) second screw hole B2 into which the screws 13 are respectively screwed, and the one second positioning hole A2 are provided for a motor mounting surface of the housing 2 on which the motor attachment plate 20 is mounted. This second positioning hole A2 is provided at a position that coincides with the first positioning hole A1 when the electric motor 9 is attached to the housing 2 at its correct position (design position). Similarly, the second screw holes B2 are provided at positions that coincide respectively with the first screw holes B1 when the electric motor 9 is attached to the housing 2 at its correct position.

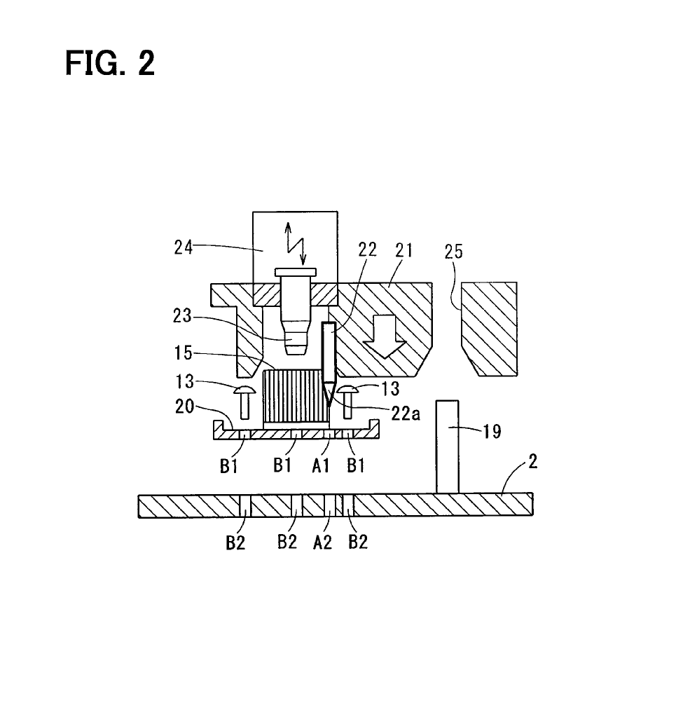

A motor positioning pin 22, which is provided for a jig 21 for motor attachment, is inserted into the first positioning hole A1 and the second positioning hole A2. The jig 21 is used when the electric motor 9 is positioned relative to the housing 2, and is provided to ascend or descend in an axial direction (upper and lower directions in FIG. 2) relative to the housing 2.

The motor positioning pin 22 is a small-diameter shaft body with its end pointed that is made of hard metal such as stainless steel. The pin 22 is fixed to the jig 21 in its longitudinal direction along the axial direction, and is provided to project from the jig 21 toward the housing 2. This motor positioning pin 22 is provided at a position that coincides with the second positioning hole A2 when the jig 21 is displaced down (brought close) to the housing 2 at a correct position.

Specifically, as a result of the downward displacement of the jig 21, the motor positioning pin 22 is inserted into the first positioning hole A1 and the second positioning hole A2, and accordingly the first positioning hole A1 and the second positioning hole A2 coincide with each other. The first positioning hole A1 and the second positioning hole A2 illustrated in this first embodiment are circular holes having generally the same diameter. A size of an outer diameter of the motor positioning pin 22 is set to be smaller than sizes of inner diameters of the first positioning hole A1 and the second positioning hole A2.

In addition to the insertion of the motor positioning pin 22 into the second positioning hole A2, a third positioning hole A3 provided for the housing 2 is used for a means for displacing upward or downward the jig 21 at the correct position of the housing 2. Separately from the above-described motor positioning pin 22, a jig positioning pin (not shown) that can be inserted into the third positioning hole

A3 is provided for the jig 21. By fitting the motor positioning pin 22 into the second positioning hole A2, and by fitting the jig positioning pin into the third positioning hole A3, the jig 21 can ascend or descend relative to the housing 2 at its correct position. A reference numeral B3 in FIG. 4B is a screw hole into which a screw for attaching the cover 14 to the housing 2 is screwed.

A motor positioning guide for positioning the shaft center of the electric motor 9 is provided for the jig 21 to improve the accuracy in engagement between the motor gear 15 and the intermediate gear 16. The motor positioning guide is configured by use of (i) a guide pin 23 that is fitted into an inner diameter hole of the motor gear 15; and (ii) a slide guide 24 to which this guide pin 23 is fixed and which can move upward or downward relative to the jig 21 in the axial direction. By fitting the guide pin 23 to the motor gear 15 with the jig 21 displaced down (brought close) to the housing 2 at its correct position, the shaft center of the electric motor 9 (i.e., the center of the rotatable shaft 18) can be arranged relative to the housing 2 at its correct position.

In addition, a through hole 25 which is formed along the axial direction (upper and lower directions in FIG. 2) is provided for the jig 21. This through hole 25 is a hole for preventing a contact between the intermediate shaft 19 and the jig 21 at the time of the ascent and descent of the jig 21 relative to the housing 2. A size of an inner diameter of the through hole 25 is set to be larger than a size of an outer diameter of the intermediate shaft 19.

In this embodiment, as described above, (i) by fitting the motor positioning pin 22 into the second positioning hole A2, and by fitting the jig positioning pin into the third positioning hole A3, the jig 21 can move up or down relative to the housing 2 at the correct position; (ii) by fitting the guide pin 23 to the motor gear 15, the shaft center of the electric motor 9 can be located relative to the housing 2 at its correct position; and (iii) by inserting the motor positioning pin 22 into the first positioning hole A1 and the second positioning hole A2, the first positioning hole A1 and the second positioning hole A2 accord with each other so that the first screw holes B1 and the second screw holes B2 can accord respectively with each other.

Thus, in this state (state where the shaft center of the electric motor 9 is positioned and where the first screw holes B1 and the second screw holes B2 accord respectively with each other), by screwing the screws 13 into the second screw holes B2 through the first screw holes B1 respectively, a defect in fastening the screws 13 is not caused and the electric motor 9 is fixed to the housing 2 at its correct position.

If a fastening tool such as a screwdriver interferes with the jig 21 when fastening the screw 13, the jig 21 is removed from the housing 2, and the screw 13 is fastened to the housing 2 with a position shift of the motor attachment plate 20 not made (e.g., with a state maintained where the motor attachment plate 20 is pressed by another jig). On the other hand, if a fastening tool such as a screwdriver does not interfere with the jig 21 when fastening the screw 13, the screw 13 is fastened to the housing 2 with the electric motor 9 positioned by the jig 21.

A first effect of the first embodiment will be described below. In the electronic throttle of this embodiment, the first positioning hole Al of the motor attachment plate 20 and the second positioning hole A2 of the housing 2 coincide with each other with the electric motor 9 attached to the housing 2. The positioning of the first positioning hole Al and the second positioning hole A2 is carried out by the motor positioning pin 22 which is used only at the time of attachment of the electric motor 9, and the electric motor 9 is thereby attached to the housing 2 with high accuracy.

The motor positioning pin 22 for making the first positioning hole A1 and the second positioning hole A2 coincide with each other is used only at the time of attachment of the electric motor 9, and the electronic throttle does not include the motor positioning pin 22 (additional component). Accordingly, the electronic throttle does not cause a cost increase due to an additional component. As a result, in the electronic throttle of this embodiment, the electric motor 9 is attached to the housing 2 with high accuracy without causing a cost increase.

A second effect of the first embodiment will be described below. In this embodiment, when the electric motor 9 is positioned relative to the housing 2, the positioning is carried out by means of the motor positioning pin 22, and the intermediate shaft 19 is not used as the motor positioning pin 22. Accordingly, there is not caused a defect of the intermediate shaft 19 being damaged at the time of attachment of the electric motor 9. Furthermore, since the motor attachment plate 20 does not need to be provided to extend to the intermediate shaft 19, a cost increase is not caused.

A third effect of the first embodiment will be described below. A distal end part 22a (lower end part in FIG. 2) of the motor positioning pin 22 is formed in a pointed manner into a conical shape. Accordingly, when the jig 21 is displaced down (brought close) to the housing 2, even if the position of the first positioning hole A1 or the second positioning hole A2 is slightly shifted relative to the motor positioning pin 22, the motor positioning pin 22 can be inserted into the first positioning hole A1 and the second positioning hole A2 because of the pointed top part of the distal end part 22a. As a result, attachability of the electric motor 9 can be improved to increase productivity of the electronic throttle.

### Second Embodiment

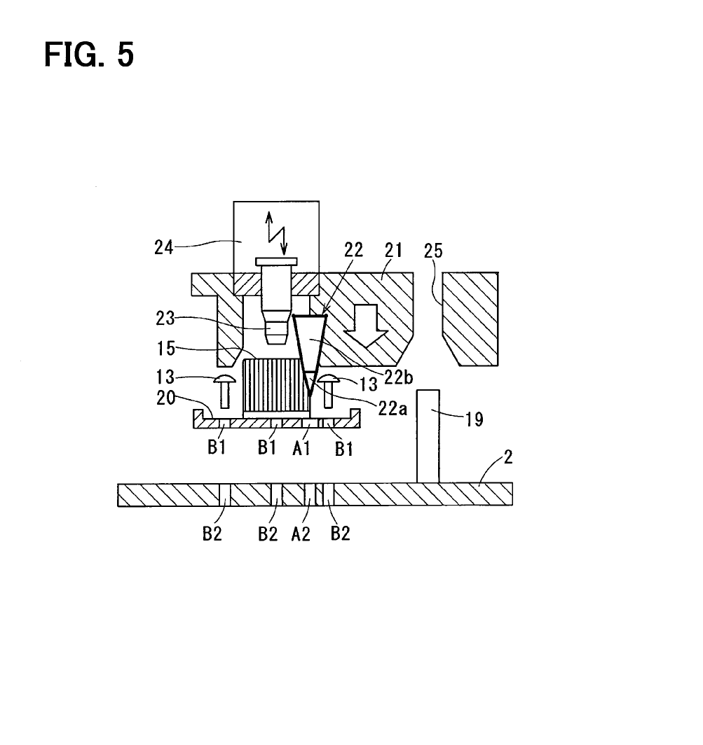

A second embodiment will be described with reference to FIG. 5. In the following embodiments, the same numerals as in the above first embodiment indicate their corresponding functional objects. In this second embodiment, (i) a hole diameter of a first positioning hole A1 is set to be larger than a hole diameter of a second positioning hole A2; and (ii) a tapered surface 22b whose diameter is reduced toward a distal end part 22a (lower side in FIG. 5) is provided on an outer peripheral surface of a motor positioning pin 22.

Accordingly, (i) even with the tapered surface 22b on the outer peripheral surface of the motor positioning pin 22, the motor positioning pin 22 can be inserted into both the first positioning hole A1 and the second positioning hole A2; and (ii) at the time of the insertion of the motor positioning pin 22 into the first positioning hole A1 and the second positioning hole A2, the tapered surface 22b is brought into contact with the first positioning hole A1, and a clearance between the motor positioning pin 22 and the first positioning hole A1 can thereby be eliminated. Therefore, as a result of the contact of the tapered surface 22b with the first positioning hole A1, a motor attachment plate 20 conforms with (follows after) the motor positioning pin 22. Consequently, accuracy in attachment of an electric motor 9 to a housing 2 can be improved.

### Third Embodiment

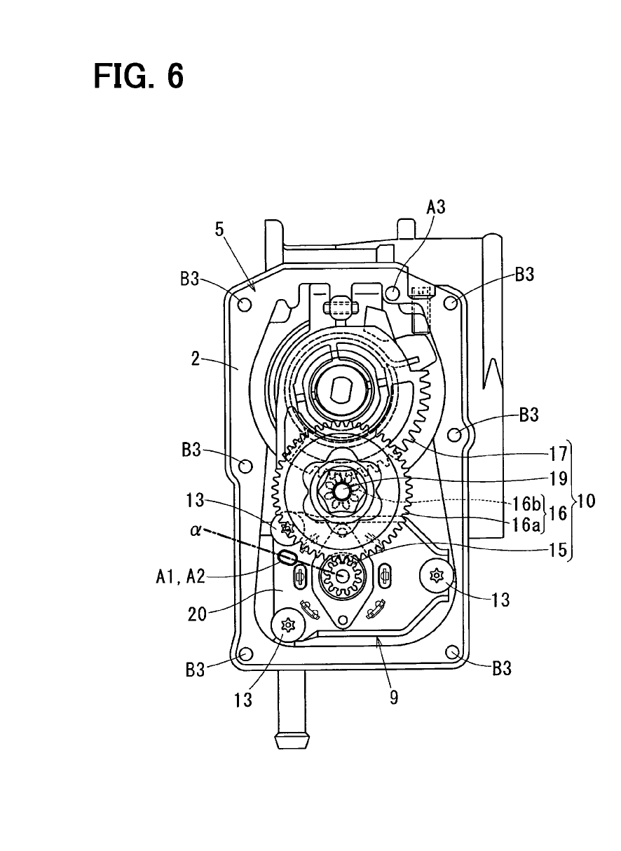

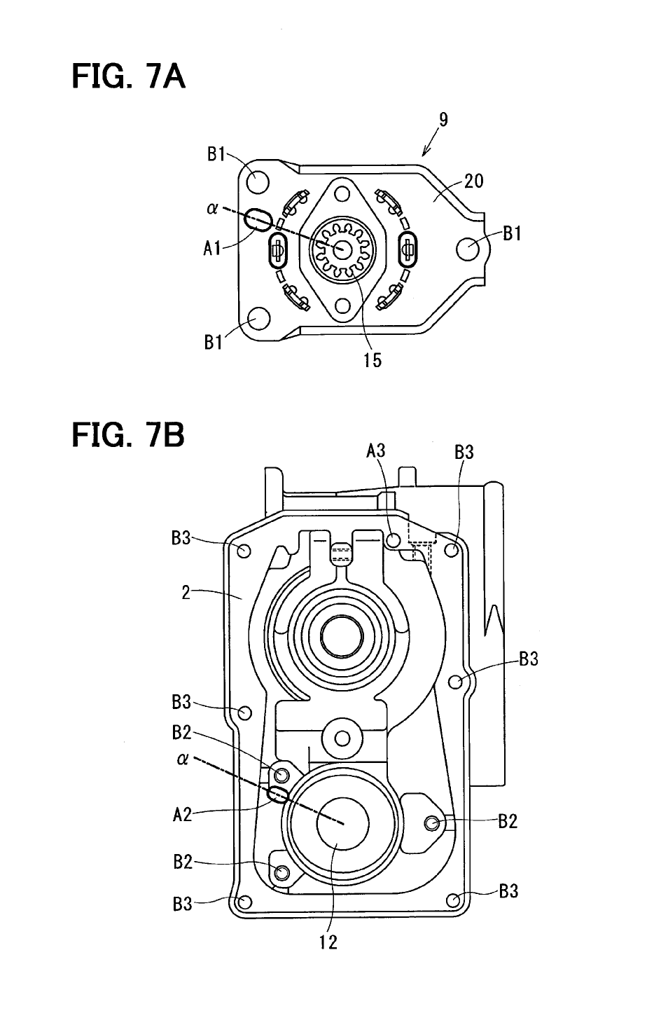

A third embodiment will be described in reference to FIGS. 6 to 7B. In this third embodiment, a first positioning hole A1 and a second positioning hole A2 are formed respectively into a shape of an elongate hole. Accordingly, clearances (a clearance between a motor positioning pin 22 and the first positioning hole A1 and a clearance between the motor positioning pin 22 and the second positioning hole A2) in a shorter direction of the elongate hole can be made small. As a result, by directing the shorter direction of the elongate hole in a direction in which high attachment accuracy is demanded, accuracy in attachment of an electric motor 9 to a housing 2 can be improved.

As one specific example, in this embodiment, a longitudinal direction (see an alternate long and short dash line a in FIGS. 7A and 7B) of the first positioning hole A1 and the second positioning hole A2 having a shape of an elongate hole is directed toward a rotatable shaft 18 of the electric motor 9. Accordingly, accuracy in attachment of a motor attachment plate 20 to the rotatable shaft 18 in its rotation direction can be improved, and accuracy in accordance between a first screw hole B1 and a second screw hole B2 can thereby be increased. Thus, fastening by screws 13 can be carried out more reliably. Industrial applicability of the present disclosure will be described below.

In the above embodiments, the pinion gear is illustrated as one example of the motor gear 15. However, the motor gear 15 is not limited to this, and another motor gears 15 such as a worm gear may be employed.

In the above embodiments, the direct-current motor is illustrated as one example of the electric motor 9. However, the electric motor 9 is not limited to this, and another electric motors 9 such as a stepping motor or switched reluctance (SR) motor may be employed.

In the above embodiments, it is illustrated that the screw 13 is used as a means for fixing the electric motor 9 to the housing 2. However, the fixing means is not limited to this, and the “positioned motor attachment plate 20” may be fixed to the housing 2 using another fixing technique such as crimping (plastic deformation) or spot welding.

In the above embodiments, the example of application of the present disclosure to the electric actuator 5 of the electronic throttle is illustrated. However, the application of the present disclosure is not limited to this. The present disclosure may be applied to various electric actuators 5 obtained by the combination of the electric motor 9 and the gear deceleration device 10, for example, an electric actuator for an exhaust gas recirculation (EGR) valve, or an electric actuator for a generator of a vortex flow such as tumble or swirl.

To sum up, the electric actuator 5 in accordance with the above embodiments can be described as follows.

In the electric actuator 5 of the present disclosure, the first positioning hole A1 of the motor attachment plate 20 and the second positioning hole A2 of the housing 2 coincide with each other with the electric motor 9 attached to the housing 2. Specifically, by the motor positioning pin 22 which is used only at the time of attachment of the electric motor 9, the positioning of the first positioning hole A1 and the second positioning hole A2 is carried out, and the electric motor 9 is attached to the housing 2 with high accuracy.

Moreover, the motor positioning pin 22 for making the first positioning hole A1 and the second positioning hole A2 coincide with each other is used only at the time of attachment of the electric motor 9, and the electric actuator 5 is not equipped with the motor positioning pin (additional component) 22. Accordingly, the electric actuator 5 does not cause a cost increase because of the additional component 22. Thus, in the present disclosure, the electric motor 9 is attached to the housing 2 with high accuracy without causing a cost increase.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. An electric actuator comprising:
an electric motor that is configured to convert electric power into rotation output;
a gear deceleration device that is configured to decelerate the rotation output of the electric motor;
a housing to which the electric motor and the gear deceleration device are attached; and
a motor attachment plate that is provided for the electric motor and is fixed to the housing, wherein a first positioning hole, which is formed through the motor attachment plate, and a second positioning hole, which is provided for the housing, coincide with each other in a state where the electric motor is attached to the housing.

2. The electric actuator according to claim 1, wherein:
a jig is used for attaching the electric motor to the housing and includes a motor positioning pin; and
the first positioning hole and the second positioning hole coincide with each other as a result of insertion of the motor positioning pin into the first positioning hole and the second positioning hole.

3. The electric actuator according to claim 2, wherein:
a hole diameter of the first positioning hole is set to be larger than a hole diameter of the second positioning hole; and
the motor positioning pin includes a tapered surface, whose diameter is reduced toward a distal end part of the motor positioning pin, on an outer peripheral surface of the motor positioning pin.

4. The electric actuator according to claim 2, wherein a distal end part of the motor positioning pin is formed in a pointed manner into a conical shape.

5. The electric actuator according to claim 4, wherein:
a hole diameter of the first positioning hole is set to be larger than a hole diameter of the second positioning hole; and
the motor positioning pin includes a tapered surface, whose diameter is reduced toward the distal end part, on an outer peripheral surface of the motor positioning pin.

6. The electric actuator according to claim 1, wherein the first positioning hole and the second positioning hole respectively have a shape of an elongate hole.

7. The electric actuator according to claim 6, wherein longitudinal directions of the first positioning hole and the second positioning hole which respectively have the shape of the elongate hole are set to be directed toward a rotatable shaft of the electric motor.

8. The electric actuator according to claim 1, wherein:
an intake passage is formed in the housing for guiding intake air into an engine;
the electric actuator is adapted for an electronic throttle including a butterfly valve that is disposed in the intake passage and a shaft that rotates integrally with the butterfly valve; and
the electric actuator is configured to rotate the shaft of the electronic throttle.
